(19) United States
(12) Patent Application Publication
(10) Pub. No.: US 2007/0088232 A1
(43) Pub. Date: Apr. 19, 2007

(54) Mat for yoga and Thai massage and method for using

(76) Inventor: Chad L. Corradini, Kailua Kona, HI (US)

Correspondence Address: BIRCH STEWART KOLASCH & BIRCH, PO BOX 747, FALLS CHURCH, VA, 22040-0747, US

(21) Appl. No.: 11/250,030

(22) Filed: Oct. 13, 2005

(51) Int. Cl. A61H 1/02; A61H 5/00

(52) U.S. Cl. 601/28

(57) ABSTRACT

A mat for yoga and Thai massage configured so as to accommodate the full body length of a practitioner in any direction with respect to the mat, and provided with functional indicia to facilitate the instruction and/or the practice of yoga, Thai massage art, and other therapeutic practices.

### BACKGROUND OF THE INVENTION

1. Field of the Invention

The present invention relates to a mat for yoga and Thai massage and a method for using the mat. In particular, the invention relates to a mat for yoga and Thai massage that is configured so as to accommodate a full body length of a user in any direction with respect to the mat, and provided with functional indicia to facilitate the instruction and/or the practice of yoga, Thai massage, and other therapeutic practices.

2. Description of Background Art

Conventional yoga mats are typically rectangular in shape, generally being 24″ to 30″ in width.

Also known, are small circular yoga mats. However, these typically have diameters smaller than the body length of the user.

None of the known conventional rectangular-shaped yoga mats or the circular mats is configured so as to accommodate the full body length of a user in any direction with respect to the mat. This presents a problem in that, when moving to certain yoga positions, a practitioner's hands or feet often are placed off the mat surface. Further, in group instruction of yoga, practitioners near each other may inadvertently hit each other's arms or legs if the mats are placed too close to each other. Further, rectangular mats typically lack the space for accommodating both a practitioner and a masseuse on the upper surface of the mat during the practice of Thai massage, and other practices.

None of the known circular mats are provided with an image of a traditional rectangular yoga mat and/or guide markers that would enable a practitioner to alternatively use the same mat for traditional yoga, 360° movement yoga, Thai massage and other health and exercise practices. The present invention is intended to address the limitations and problems of conventional yoga mats.

### BRIEF SUMMARY OF THE INVENTION

According to a first aspect of the present invention, a circular-shaped mat is provided, the mat having an upper surface and a center of the upper surface, radii of the mat being at least two and one/half feet; and a first patterned design on the upper surface of the mat, the first patterned design including indicia disposed along the radii of the mat, thereby dividing the upper surface into at least two sectors, the first patterned design functioning as guide markers to aid a yoga or Thai massage practitioner when moving among yoga or Thai massage positions.

According to a second aspect of the present invention, the circular-shaped mat is further provided with a second patterned design centrally disposed and not extending beyond the outer edges of the mat and having a longitudinal axis that is coincident with at least one of the indicia of the first patterned design and extending along the radii of at least one of the first patterned design, and having a center coincident with the center of the upper surface of the mat, the second patterned design defining an outline of a rectangular-shaped yoga mat, and configured to aid the yoga or the Thai massage practitioner to transition between practicing on the outline of the rectangular-shaped mat while on the circular upper surface of the mat.

According to a third aspect of the present invention, a polygonal-shaped mat is provided, the mat having at least four sides, an upper surface having a center, and a width or a length having a dimension of at least five feet; and a first patterned design on the upper surface of the mat, the first patterned design including indicia, each of the indicia disposed so as to intersect the center of the mat and outer sides of the mat and dividing the upper surface of the mat into at least two areas, the first patterned design functioning as guide markers to aid a yoga or Thai massage practitioner when moving among yoga or Thai massage positions.

According to a fourth aspect of the present invention, the polygonal-shaped mat is further provided with a second patterned design centrally disposed and not extending beyond the outer sides of the mat and having a longitudinal axis that is coincident with at least one of the indicia of the first patterned design and extending along the radii of at least one of the indicia of the first patterned design, and having a center coincident with the center of the upper surface of the mat.

The second patterned design defining an outline of a rectangular-shaped yoga mat, and so configured as to aid a yoga or Thai massage practitioner to transition between practicing on the outline of the rectangular-shaped mat the on the full area of the upper surface of the mat.

The present invention also encompasses a method for guiding a user in the practice of therapeutic arts, such as yoga and Thai massage, on a circular or polygonal shaped mat with radii of the upper surface being at least two and one/half feet and which has a first patterned design on the upper surface that divides the upper surface into at least two sectors and functions as guide markers to aid in moving among therapeutic positions, such as yoga and Thai massage positions. The method encompasses positioning the body of the user at the center of the mat, using a first indicia to guide a first portion of the body towards a first intended position, using a second indicia to guide the first portion or another portion of the body to a second intended position and then observing relative distances and/or angles between the first portion of the body and the first indicia, and/or between the first portion or the another portion of the body and the second intended position in order to assess whether or not the intended positions have been attained by the user.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates a circular mat for yoga and Thai massage large enough to fit an image of a conventional rectangular yoga mat thereon in any orientation; and

FIG. 2 illustrates an octagonal shaped mat for yoga and Thai massage large enough to fit an image of a conventional rectangular yoga mat therein in any orientation;

FIG. 3 illustrates the circular mat for yoga and Thai massage of FIG. 1 with guide markers in the form of a human image and lines; and

FIGS. 4(a) and 4(b) illustrate the circular mat for yoga and Thai massage of FIG. 1 with guide markers in the form of chakras.

### DETAILED DESCRIPTION OF THE PREFERRED EMBODIMENTS

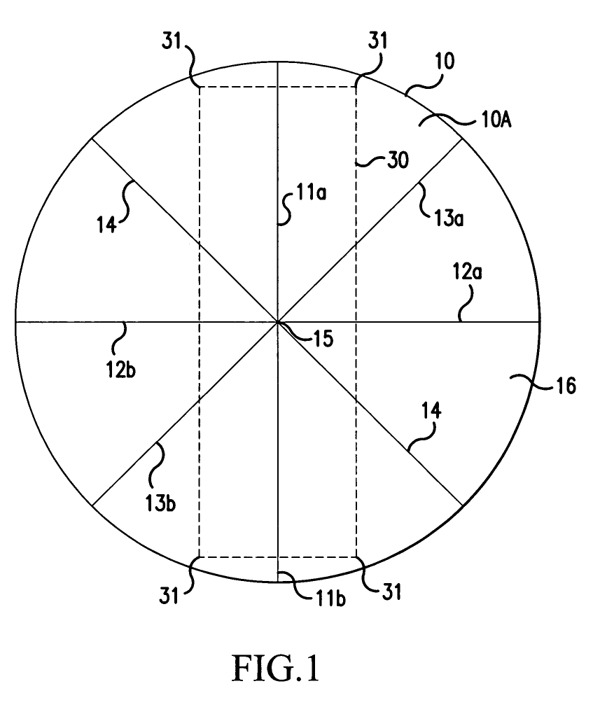

FIG. 1 illustrates a circular mat for yoga and Thai massage 10 that is large enough to fit an image of a conventional rectangular-shaped yoga mat 30 formed on the upper surface 1OA of the mat. The image of the conventional yoga mat 30 is disposed such that the image does not extend beyond edges of the mat 10. Further, the circular mat 10 may have a diameter equal to at least five (5) feet, six (6) feet, seven (7) feet, eight (8) feet or greater, the size being set to be long enough to accommodate the full body length of the yoga or Thai massage practitioner, and with consideration being given to the available floor space on which to lay the mat 10.

The image of the conventional yoga mat 30 serves to permit the circular yoga mat 10 to be used for the practice of traditional yoga, or as a mat that a practitioner may use to transition from the practice of traditional yoga to other forms of yoga involving postures at any radial angle around the center of the mat. The circular shape and size of the mat 10 enable the practitioner at the center point 15 of the mat 10 to move to traditional yoga, 360° movement yoga, or Thai massage positions at any radial angle of the mat without positioning hands and feet off the upper surface 10A of the mat 10. The mat is formed of a single piece of skid resistant, flexible, and compressible material, so that skidding of the yoga or Thai massage practitioner is minimized. The thickness of the mat may be from 1/16″ to 1″ depending on the material from which it is manufactured, and is easily portable and capable of being rolled up.

In addition, if a yoga class is being conducted in which several student practitioners are situated in an instruction room, the circular shape and size of the mat provides adequate spacing between the practitioners, thereby ensuring that the student practitioners on adjoining mats do not inadvertently hit each other during arm and leg movements.

The outline of a conventional rectangular yoga mat 30 may be formed such that corners 31 lie on the circumferential edge of the mat 10, or may lie inward from the circumferential edge of the mat, say inward by one (1) to six (6) inches from the circumferential edge, for example.

Two vertical line guide markers (indicia) 11a, 11b, and two horizontal line guide markers (indicia) 12a, 12b, extending radially from the center point, and additional guide markers (indicia) 13a, 14a, 13b and 14b extending radially from the center point at angles of 45°, 135°, 225°, and 315°, respectively. As shown in FIG. 1, guide markers 11a, 12a, 13a, 14a, 11b, 12b, 13b, and 14b extend outwardly toward the outer perimeter of the mat, and as such, divide the upper surface 10A of the mat into equal-sized segments 16.

The image of the conventional rectangular mat 30 and the guide markers 11a, 12a, 13a, 14a, 11b, 12b, 13b, and 14b serve multiple functions for the practitioner, and also for an instructor providing instruction to one or more student practitioners in a class.

For an individual student or practitioner, the guide markers 11a, 12a, 13a, 14a, 11b, 12b, 13b, and 14b provide a frame of reference and guidance when moving to, from, and among different postures. For example, a beginning student practicing alone may rely on all (or most all) of the guide markers 11a, 12a, 13a, 14a, 11b, 12b, 13b, and 14b when moving among a sequence of positions during yoga practice. Other the other hand, a more advanced practitioner may rely only on a few or none of the guide markers 11a, 12a, 13a, 14a, 11b, 12b, 13b, and 14b, or perhaps only rely on the outline 30 of the traditional yoga mat during practice.

Thus, the outline 30 of the traditional yoga mat and the guide markers 11a, 12a, 13a, 14a, 11b, 12b, 13b, and 14b may be used by a sole practitioner (beginning or advanced) when moving among a sequence of positions, as well as a practitioner moving between traditional yoga practice (guided solely by the outline 30 of the traditional yoga) and guided yoga practice (guided by some or all of the guide markers 11a, 12a, 13a, 14a, 11b, 12b, 13b, and 14b).

For the instructor, the outline of the conventional yoga mat 30 and the guide markers 11a, 12a, 13a, 14a, 11b, 12b, 13b, and 14b can ensure that multiple students all have their mats aligned in the same direction at the start of group instruction, the outline of the conventional yoga mat 30 and the guide markers 11a, 12a, 13a, 14a, 11b, 12b, 13b, and 14b on each mat providing consistent guidance to all students when the instructor is leading the students among different movements. Further, during instruction of one or more students, the outline of the conventional yoga mat 30 and the guide markers 11a, 12a, 13a, 14a, 11b, 12b, 13b, and 14b provide reference points by which the instructor is able to guide the students among different positions and postures, as well as to gauge how well each student is attaining the intended positions and postures.

The image of the conventional rectangular yoga 30 mat, as well as guide markers 11a, 12a, 13a, 14a, 11b, 12b, 13b, and 14b, may be formed with solid or broken lines. For example, beginning practitioners may find that solid-line guide markers from the center point 15 to the edges of the upper surface 10A of the mat provide the best positive visual guidance during practice, whereas more advanced practitioners may find broken-line guide markers, e.g., more subtle lines, to be more suitable. Further, more advanced practitioners may not need each and every guide marker 11a, 12a, 13a, 14a, 11b, 12b, 13b, and 14b. Generally however, guide markers 11a, 11b, 12a, and 12b are provided, or at least guide markers 11a and 11b are provided.

The circular shape and size of the mat 10 also allow the mat to be used for the practice of Thai massage as well as many other therapeutic practices, since the mat 10 is large enough to accommodate both the practitioner and a masseuse. For example, the practitioner may be lying down or in another position on the mat near the center of the mat, say, while the masseuse may also be on the mat, kneeling for example on one side of the practitioner.

The guide markers also provide a frame of reference for the Thai massage recipient and/or masseuse. For example, the recipient can be positioned within or along the outline 30 of the traditional yoga mat or the guide markers 11a, 12a, 13a, 14a, llb, 12b, 13b and 14b. Alternatively, the recipient's head and torso can be positioned along any one of the guide markers 11a, 12a, 13a, 14a, 11b, 12b, 13b and 14b while the arm and/or leg is placed along an adjacent guide marker. Similarly, the masseuse may use the guide markers to gauge the best angle or position from which to apply the massage exercise to the recipient. The masseuse may also use the guide markers to monitor the extent and/or progress of the recipient's muscle extension or relaxation by comparing the relative distances between the body and the guide markers during the course of the massage. Thus the guide markers serve to facilitate the Thai massage effect for both recipient and masseuse practitioners.

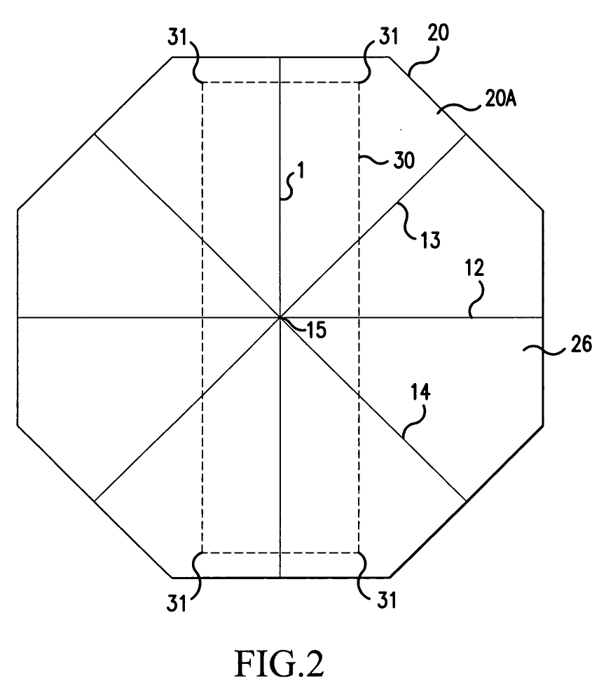

FIG. 2 illustrates an octagonal-shaped mat for yoga and Thai massage 20 offering the same advantages as the mat for yoga and Thai massage 10 of FIG. 1. As with the mat for yoga and Thai massage of FIG. 1, octagonal mat for yoga and Thai massage 20 is large enough to fit an image of a conventional rectangular-shaped yoga mat 30 formed on the upper surface 200A of the mat. The image of the conventional yoga mat 30 is disposed so as not the extend beyond the sides of the mat 20. The circular mat 20 may have a dimensions between opposite parallel sides of at least 5 feet, 6 feet, 7 feet, 8 feet or greater, the dimensions being set to be long enough to accommodate the full body length of the yoga or Thai massage practitioner, and with consideration being given to the available floor space on which to lay the mat 20.

As with the circular mat of FIG. 1, the octagonal mat 20 has two vertical line guide markers (indicia) 11a, 11b, and two horizontal line guide markers (indicia) 12a, 12b, extending radially from the center point, and additional guide markers (indicia) 13a, 14a, 13b and 14b extending radially from the center point at angles of 45°, 135°, 225°, and 315°, respectively. As shown in FIG. 1, guide markers 11a, 12a, 13a, 14a, 11b, 12b, 13b, and 14b extend outward to the outer perimeter of the mat, and as such divide the upper surface 10A of the mat into equal-sized area 26.

The outline of a conventional rectangular yoga mat 30 may be formed such that the corners 31 lie on two of the flat side edges of the mat 20, or may lie inward from the sides edges of the mat, say, inward by one (1) to six (6) inches from the side edge, for example.

Other than having straight side edges, the materials, patterned designs, and functions of the octagonal mat 20 are the same that of the circular mat 10 shown in FIG. 1.

However, the straight edges of the octagonal mat 20 shown in FIG. 2 allow mat 20 to require slightly less floor space between octagonal mats. This is due to being able to have the straight side edges of adjoining mats abut against each other, or to being able to have the straight sides edges of one or more mats to abut against a vertical wall. Further, the octagonal-shaped mats can be made with less material, thereby minimizing cost.

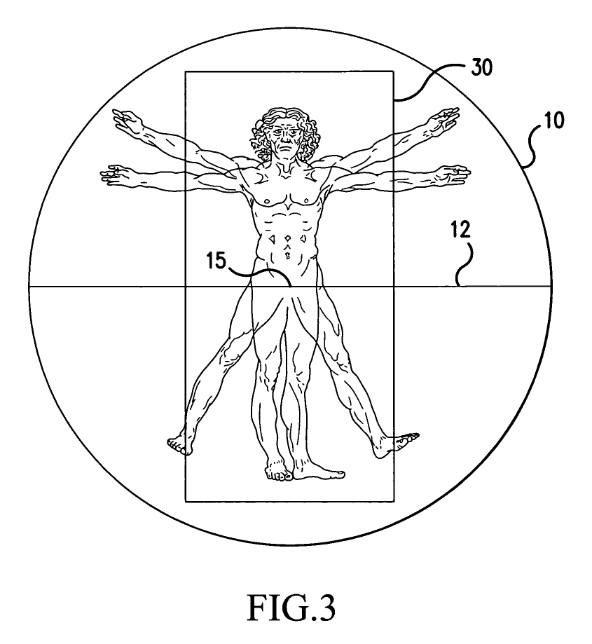

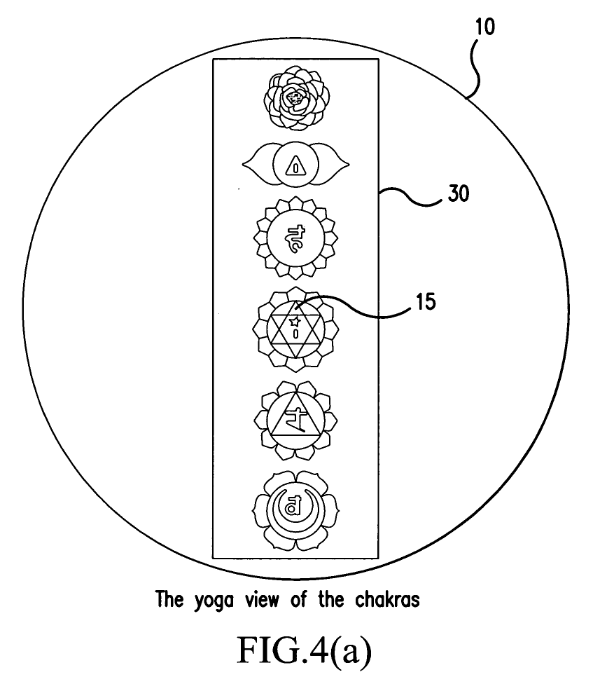

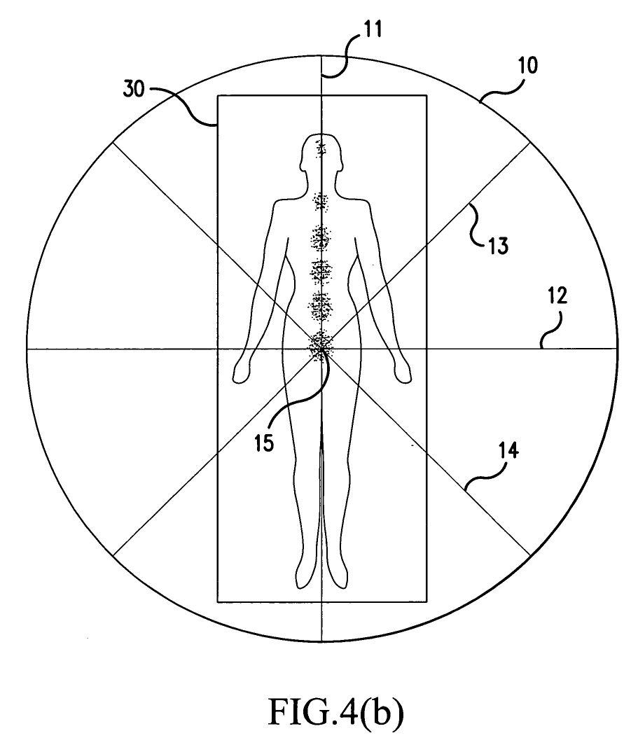

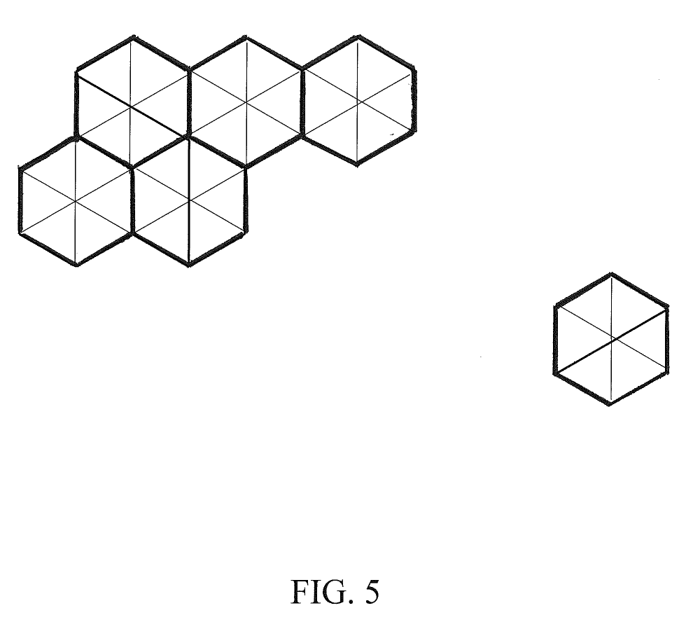

FIG. 3 illustrates the circular mat for yoga and Thai massage of FIG. 1 with guide markers in the form of a human image and lines; and FIGS. 4(a) and 4(b) illustrates the circular mat for yoga and Thai massage of FIG. 1 with guide markers in the form of chakras.

In the case of FIGS. 3, 4(a), and 4(b) the human form 30 and the chakras form 30 are provided as alternatives to or complements to the outline of the image of conventional yoga mat 30 and any or all of the linear guide markers 11a, 11b, 12a, 12b, 13a, 13b, 14a, and 14b. Further the outline of the human form 30 in FIG. 3, and the outline of the chakras 30 in FIGS. 4(a) and (b) can be used interchangeably or in addition to any or all of the linear guide markers 11a, 11b, 12a, 12b, 13a, 13b, 14a, and 14b of the mats of FIGS. 1 and 2.

While circular and octagonal-shaped mats have been described above, other mat shapes should be considered within the scope of the present invention.

For example, an oval-shaped mat may be used in lieu the circular-shaped mat 10 as shown in FIG. 1.

In addition, regarding polygonal-shaped mats, mats with other than the eight sides of mat 20 of FIG. 2 may be used. For example, a four-sided or a six-sided mat may be formed.

Generally polygonal-shaped mats have an even number of sides, but an odd number of sides may be used, for example, five or seven sides. Generally polygonal-shaped mats are equilateral in shape. However, sides and angles between the sides need not be the same. Further the guide markers may be aligned on radii which intersect the sides or corners between the sides.

The number of indicia (guide markers) may range from 2 to 8. Further, while the indicia are aligned radially, the angles between adjoining indicia need not be equal. Further, any combination of solid-line, broken-line, and pictorial indicia may be used.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A mat for yoga and Thai massage, comprising:
circular-shaped mat having an upper surface, a circular outer edge and a center of the upper surface, with diameters of the upper surface being at least five feet, wherein the circular-shaped mat for yoga and Thai massage is formed of a skid resistant, flexible, and compressible material so that skidding of the yoga and Thai massage practitioner is minimized, and so that the circular-shaped mat may be rolled up when not in use; and
a first patterned design on the upper surface of the mat, the first patterned design including four or more indicia passing through the center of the upper surface each of the indicia being disposed along one of the diameters of the mat, thereby dividing the upper surface into eight or more pie shaped-sectors, the indicia functioning as guide markers to aid a yoga and Thai massage practitioner when moving among yoga and Thai massage positions.

2. The mat for yoga and Thai massage of claim 1, further comprising
a second rectangular-shaped patterned design centrally disposed and not extending beyond the outer circular edge of the mat and having a longitudinal axis that is coincident with at least one of the indicia of the first patterned design and extending along one of the diameters, and having a center coincident with the center of the upper surface of the circular-shaped mat,
the second rectangular-shaped patterned design defining an outline of a rectangular-shaped yoga mat, and configured to aid the yoga and the Thai massage practitioner to transition between practicing within the outline of the rectangular-shaped mat and an entire circular upper surface of the circular-shaped mat.

3. The mat for yoga and Thai massage of claim 2, wherein the second rectangular-shaped patterned design includes 90° corners and solid or broken lines forming sides of the second rectangular-shaped patterned design.

4. The mat for yoga and Thai massage of claim 2, wherein the second rectangular-shaped patterned design has four corners that are spaced adjacent to and inward from the outer circular edge of the upper surface of the circular-shaped mat.

5. The mat for yoga and Thai massage of claim 2, wherein the second rectangular-shaped patterned design has four corners meeting the outer circular edge of the upper surface of the circular-shaped mat.

6. The mat for yoga and Thai massage of claim 1, wherein the indicia of the first patterned design are four to eight indicia.

7. The mat for yoga and Thai massage of claim 1, wherein all of the sectors are equal-sized.

8. The mat for yoga and Thai massage of claim 1, wherein the indicia of the first patterned design include an image of a human figure provided on the upper surface of the circular-shaped mat, a torso of the human figure being disposed along a vertical diameter of the circular-shaped mat, and arms and legs extending at angles from the vertical diameter.

9. (canceled)

10. The mat for yoga and Thai massage of claim 1, wherein the circular-shaped mat is formed of a single piece of material.

11. (canceled)

12. The mat for yoga and Thai massage of claim 1, wherein indicia of the second rectangular-shaped patterned design has two longitudinal sides with lengths in the range of 54 to 70 inches and two short sides with lengths in the range of 22 to 27 inches.

13. The mat for yoga and Thai massage of claim 1, wherein the first patterned design are guide markers for the practitioner when practicing yoga and Thai massage positions performed at angles of 360° around the center of the circular-shaped mat.

14. The mat for yoga and Thai massage of claim 1, wherein the circular shape and size of the circular-shaped mat enable the practitioner at the center of the circular-shaped mat to move among yoga, Thai massage, and other therapeutic positions at any radial angle of the circular-shaped mat without positioning hands and feet off the upper surface of the circular-shaped mat.

15. A mat for yoga and Thai massage, comprising:
a polygonal-shaped mat having at least six sides, an upper surface having a center, and a width and a length having dimensions of at least five feet, wherein the polygonal-shaped mat for yoga and Thai massage is formed of skid resistant, flexible, and compressible material, so that skidding of the yoga and Thai massage practitioner is minimized, and so that polygonal-shaped mat may be rolled up when not in use; and
a first patterned design on the upper surface of the polygonal-shaped mat, the first patterned design including indicia disposed so that each of the indicia intersects the center of the mat and outer sides of the polygonal-shaped mat and divides the upper surface of the polygonal-shaped mat into two or more areas, each of the areas being equal in size and shape, the indicia functioning as guide markers to aid a yoga and Thai massage practitioner when moving among yoga and Thai massage positions.

16. The mat for yoga and Thai massage of claim 15, further comprising
a second rectangular-shaped patterned design centrally disposed and not extending beyond the outer sides of the polygonal-shaped mat and having a longitudinal axis that is coincident with at least one of the indicia of the first patterned design and extending along a length of the at least one of indicia of the first patterned design, and having a center coincident with the center of the upper surface of the polygonal-shaped mat.
the second patterned design defining an outline of a rectangular-shaped yoga mat, and so configured as to aid a yoga and Thai massage practitioner to transition between practicing within the outline of the rectangular-shaped mat and a full area of the upper surface of the polygonal-shaped mat.

17. The mat for yoga and Thai massage of claim 15, wherein the number of the outer sides of the polygonal-shaped mat is between six and eight.

18. The mat for yoga and Thai massage of claim 15, wherein a plurality of polygonal-shaped mats are used on a common flat surface, straight sides of adjoining polygonal-shaped mats are capable of abutting together, thereby minimizing an amount of space required on the common flat surface to accommodate the plurality of polygonal-shaped mats.

19. The mat for yoga and Thai massage of claim 15, wherein the polygonal-shaped mat is formed of a single piece of material.

20. A method for guiding a user in the practice of therapeutic arts on a mat for yoga and Thai massage, the mat being circular-shaped and having an upper surface and a center of the upper surface, with diameters of the upper surface being at least five feet, wherein the circular-shaped mat for yoga and Thai massage is formed of skid resistant, flexible, and compressible material, so that skidding of the yoga and Thai massage practitioner is minimized and so that circular-shaped mat may be rolled up when not in use; the mat having a first patterned design on the upper surface of the mat, the first patterned design including one or more indicia, each of the indicia being disposed along one of the diameters of the mat, thereby dividing the upper surface into two or more sectors, each of the sectors being equal in size and shape, the indicia functioning as guide markers to aid a yoga and Thai massage practitioner when moving among yoga and Thai massage positions, the method comprising the steps of:
positioning a body of the user at the center of the mat;
using a first one of the indicia to guide at least a first portion of the body toward a first intended position;
using a second one of the indicia to guide the at least first portion or another portion of the body to a second intended position; and
observing relative distances between the first portion of the body and the first one of the indicia, and/or between the first portion or the another portion of the body and the second intended position, in order to assess whether or not the intended positions have been attained by the user.

21. The mat for yoga and Thai massage of claim 1, wherein the diameter of the upper surface is 5-7 feet.

22. The mat for yoga and Thai massage of claim 1, wherein the center is identified by the intersection of the indicia that is used by said practitioner to position the practitioner's body at the center of the mat and wherein a first one of the indicia is adapted for guiding at least a first portion of the body toward a first intended position and a second one of the indicia is adapted for guiding the at least first portion or another portion of the body to a second intended position.
